(19) United States
(12) Patent Application Publication
(10) Pub. No.: US 2005/0149337 A1
(43) Pub. Date: Jul. 7, 2005

(54) Automatic speech recognition to control integrated communication devices

(75) Inventors: Ayman O. Asadi, Laguna Niguel, CA (US); Aruna Bayya, Irvine, CA (US); Dianne L. Steiger, Irvine, CA (US)

Correspondence Address: Mr. Christopher John Rourk;GODWIN GRUBER, LLP, 1201 Elm Street, Renaissance Tower, DALLAS, TX, 75270, US

(73) Assignee: Conexant Systems, Inc., Newport Beach, CA (US)

(21) Appl. No.: 11/060,193

(22) Filed: Feb. 17, 2005

Related U.S. Application Data
(63) Continuation of application No. 09/396,280, filed on Sep. 15, 1999, now abandoned.

(51) Int. Cl. G10L 15/00

(52) U.S. Cl. 704/277

(57) ABSTRACT

An integrated communications device provides an automatic speech recognition (ASR) system to control communication functions of the communications device. The ASR system includes an ASR engine and an ASR control module with an out-of-vocabulary rejection capability. The ASR engine performs speaker independent and dependent speech recognition and also performs speaker dependent training. The ASR engine thus includes a speaker dependent recognizer, a speaker independent recognizer and a speaker dependent trainer. Speaker independent models and speaker dependent models stored on the communications device are used by the ASR engine. A speaker dependent mode of the ASR system provides flexibility to add new language independent vocabulary. A speaker independent mode of the ASR system provides the flexibility to select desired commands from a predetermined list of speaker independent vocabulary. The ASR control module, which can be integrated into an application, initiates the appropriate communication functions based on speech recognition results from the ASR engine. One way of implementing the ASR system is with a processor, controller and memory of the communications device. The communications device also can include a microphone and telephone to receive voice commands for the ASR system from a user.

### BACKGROUND

1. Field of the Invention

The present invention generally relates to automatic speech recognition to control integrated communication devices.

2. Description of the Related Art

With certain communication devices such as facsimile machines, telephone answering machines, telephones, scanners and printers, it has been necessary for users to remember various sequences of buttons or keys to press in order to activate desired communication functions. It has particularly been necessary to remember and use various sequences of buttons with multiple function peripherals (MFPs). MFPs are basically communication devices that integrate multiple communication functions. For example, a multiple function peripheral may integrate facsimile, telephone, scanning, copying, voicemail and printing functions. Multiple function peripherals have provided multiple control buttons or keys and multiple communication interfaces to support such communication functions. Control panels or keypad interfaces of multiple function peripherals therefore have been somewhat troublesome and complicated. As a result, communications device users have been frustrated in identifying and using the proper sequences of buttons or keys to activate desired communication functions.

As communication devices have continued to integrate more communication functions, communication devices have become increasingly dependent upon the device familiarity and memory recollection of users.

Internet faxing will probably further complicate use of fax-enabled communication devices. The advent of Internet faxing is likely to lead to use of large alphanumeric keypads and longer facsimile addresses for fax-enabled communication devices.

### SUMMARY OF THE INVENTION

Briefly, an integrated communications device provides an automatic speech recognition (ASR) system to control communication functions of the communications device. The ASR system includes an ASR engine and an ASR control module with out-of-vocabulary rejection capability. The ASR engine performs speaker independent and dependent speech recognition and also performs speaker dependent training. The ASR engine thus includes a speaker independent recognizer, a speaker dependent recognizer and a speaker dependent trainer. Speaker independent models and speaker dependent models stored on the communications device are used by the ASR engine. A speaker dependent mode of the ASR system provides flexibility to add new language independent vocabulary. A speaker independent mode of the ASR system provides the flexibility to select desired commands from a predetermined list of speaker independent vocabulary. The ASR control module, which can be integrated into an application, initiates the appropriate communication functions based on speech recognition results from the ASR engine. One way of implementing the ASR system is with a processor, controller and memory of the communications device. The communications device also includes a microphone and telephone to receive voice commands for the ASR system from a user.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of a communications device illustrating an automatic speech recognition (ASR) control module running on a host controller and a processor running an automatic speech recognition (ASR) engine;

FIG. 2 is a block diagram of an exemplary model for the ASR system of FIG. 1;

FIG. 3 is a control flow diagram illustrating exemplary speaker dependent mode command processing with the host controller and the processor of FIG. 1;

FIG. 4 is a control flow diagram illustrating exemplary speaker independent mode command processing with the host controller and the processor of FIG. 1;

FIG. 5 is a control flow diagram illustrating exemplary speaker dependent training mode command processing with the host controller and the processor of FIG. 1;

FIG. 6A is an illustration of an exemplary menu architecture for the ASR system of FIG. 1;

FIG. 6B is an illustration of exemplary commands for the menu architecture of FIG. 6A;

FIG. 7 is a flow chart of an exemplary speaker dependent training process of the trainer of FIG. 2; and

FIG. 8 is a flow chart of an exemplary recognition process of the recognizer of FIG. 2.

### DETAILED DESCRIPTION OF PREFERRED EMBODIMENT

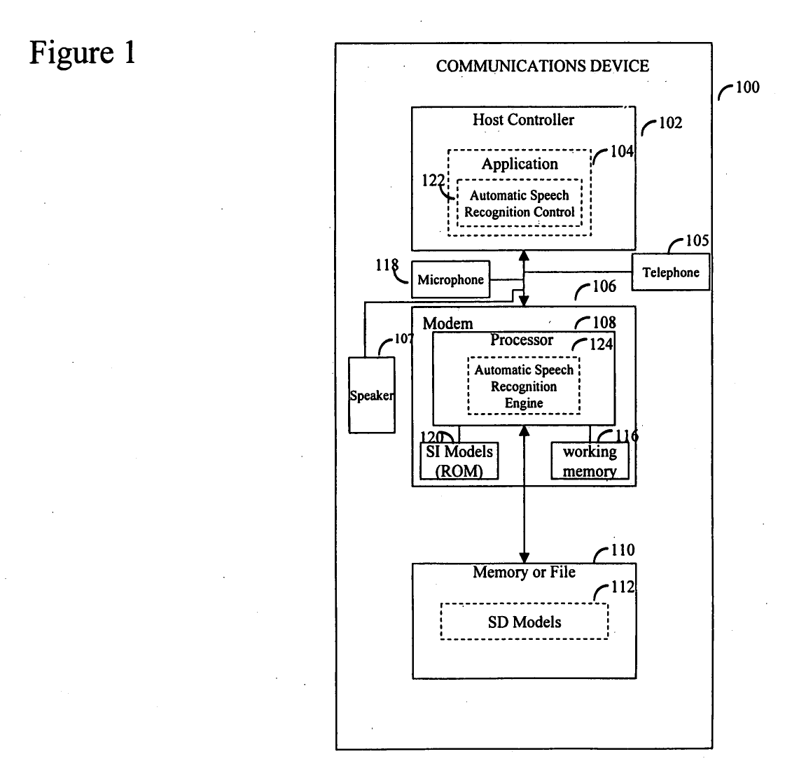

Referring to FIG. 1, an exemplary communications device 100 utilizing an automatic speech recognition (ASR) system is shown. An ASR engine 124 can be run on a processor such as a digital signal processor (DSP) 108. Alternatively, the ASR system can be run on other processors. In a disclosed embodiment, the processor 108 is a fixed point DSP. The processor 108, a read only memory containing trained speaker independent (SI) models 120, and a working memory 116 are provided on a modem chip 106 such as fax modem chip. The SI models 120, for example, may be in North American English. The modem chip 106 is coupled to a host controller 102, a microphone 118, a telephone 105, a speaker 107, and a memory or file 110. The memory or file 110 is used to store speaker dependent (SD) models 112. The SD models 112, for example, might be in any language other than North American English. The working memory 106 is used by the processor 108 to store SI models 120, SD models 112 or other data for use in performing speech recognition or training. For sake of clarity, certain conventional components of a modem which are not critical to the present invention have been omitted.

An application 104 is run on the host controller 102. The application 104 contains an automatic speech recognition (ASR) control module 122. The ASR control module 122 and the ASR engine 124 together generally serve as the ASR system. The ASR engine 124 can perform speaker dependent and speaker independent speech recognition. Based on a recognition result from the ASR engine 124, the ASR control module 122 performs the proper communication functions of the communication device 100. A variety of commands may be passed between the host controller 102 and the processor 108 to manage the ASR system. The ASR engine 124 also handles speaker dependent training. The ASR engine 124 thus can include a speaker dependent trainer, a speaker dependent recognizer, and a speaker independent recognizer. In other words, the ASR engine 124 supports a training mode, an SD mode and an SI mode. These modes are described in more detail below. While the ASR central module 122 is shown running on the host controller 102 and the ASR engine 124 is shown running on the processor 108, it should be understood that the ASR control module 122 and the ASR engine 124 can be run on a common processor. In other words, the host controller functions may be integrated into a processor.

The microphone 118 detects voice commands from a user and provides the voice commands to the modem 106 for processing by the ASR system. Voice commands alternatively may be received by the communications device 100 over a telephone line or from the local telephone handset 105. By supporting the microphone 118 and the telephone 105, the communications device 100 integrates microphone and telephone structure and functionality. It should be understood that the integration of the telephone 105 is optional.

The ASR system, which is integrally designed for the communications device 100, supports an ASR mode of the communications device 100. In a disclosed embodiment, the ASR mode can be enabled or disabled by a user. When the ASR mode is enabled, communication functions of the communications device 100 can be performed in response to voice commands from a user. The ASR system provides a hands-free capability to control the communications device 100. When the ASR mode is disabled, communication functions of the communication device 100 can be initiated in a conventional manner by a user pressing control buttons and keys (i.e., manual operation). The ASR system does not demand a significant amount of memory or power from the modem 106 or the communications device 100 itself.

In a disclosed embodiment of the communications device 100, the SI models 120 are stored on-chip with the modem 106, and SD models 112 are stored off-chip of the modem 106 as shown in FIG. 1. As noted above, the ASR engine 124 may function in a SD mode or a SI mode. In the SD mode, words can be added to the SD vocabulary (defined by the SD models 112) of the ASR engine 124. For example, the ASR engine 124 can be trained with names and phone numbers of persons a user is likely to call. In response to a voice command including the word “call” followed by the name of one of those persons, the ASR engine 124 can recognize the word “call” and separately recognize the name and can instruct the ASR control module 122 to initiate dialing of the phone number of that person. In a similar fashion, a trained fax number can also be initiated by voice commands. The SD mode thus permits a user to customize the ASR system to the specific communication needs of the user. In the SI mode, the SI vocabulary (defined by the SI models 120) of the ASR engine 124 is fixed. Desired commands may be selected by an application designer from the SI vocabulary. Generating the trained SI models 120 to store on the modem 106 can involve recording speech both in person and over the telephone from persons across different age and other demographics which speak a particular language. Those skilled in the art will appreciate that certain unhelpful speech data may be screened out.

The application 104 can serve a variety of purposes with respect to the ASR system. For example, the application 104 may support any of a number of communication functions such as facsimile, telephone, scanning, copying, voicemail and printing functions. The application 104 may even be used to compress the SI models 120 and the SD models 112 and to decompress these models when needed. The application 104 is flexible in the sense that an application designer can build desired communication functions into the application 104. The application 104 is also flexible in the sense that any of a variety of applications may utilize the ASR system.

It should be apparent to those skilled in the art that the ASR system may be implemented in a communications device in a variety of ways. For example, any of a variety of modem architectures can be practiced in connection with the ASR system. Further, the ASR system and techniques can be implemented in a variety of communication devices. The communications device 100, for example, can be a multi-functional peripheral, a facsimile machine or a cellular phone. Moreover, the communications device 100 itself can be a subsystem of a computing system such as a computer system or Internet appliance.

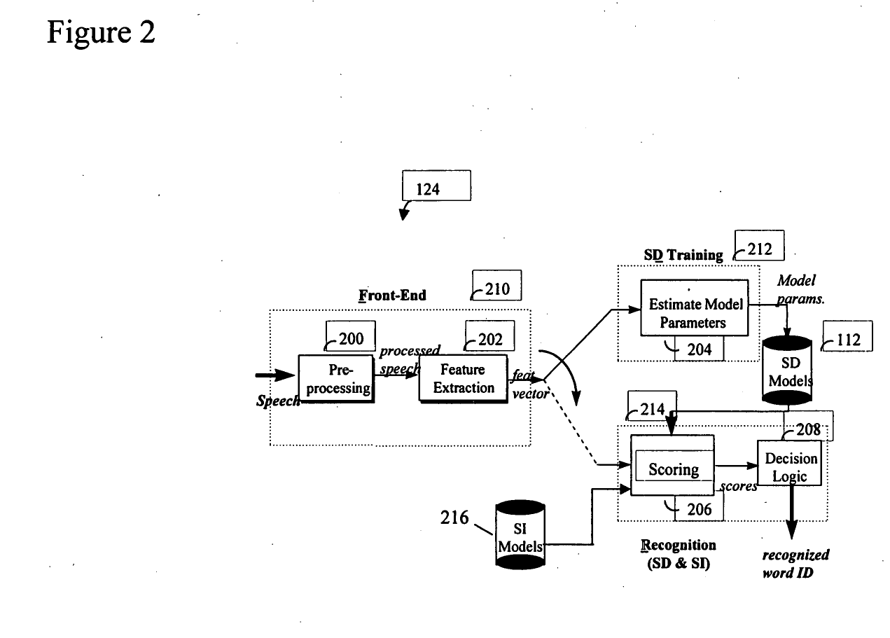

Referring to FIG. 2, a general exemplary model of the ASR engine 124 is illustrated. The ASR engine 124 shown includes a front-end 210, a trainer 212 and a recognizer 214. The front-end 210 includes a pre-processing or endpoint detection block 200 and a feature extraction block 202. The pre-processing block 200 can be used to process an utterance to distinguish speech from silence. The feature extraction block 202 can be used to generate feature vectors representing acoustic features of the speech. Certain techniques known in the art, such as linear predictive coding (LPC) modeling or perceptual linear predictive (PLP) modeling for example, can be used to generate the feature vectors. As understood in the art, LPC modeling can involve Cepstral weighting, Hamming windowing, and auto-correlation. As is further understood in the art, PLP modeling can involve Hamming windowing, auto-correlation, spectral modification and performing a Discrete Fourier Transform (DFT).

As illustrated, the trainer 212 can use the feature vectors provided by the front-end 210 to estimate or build word model parameters for the speech. In addition, the trainer 212 can use a training algorithm which converges toward optimal word model parameters. The word model parameters can be used to define the SD models 112. Both the SD models 112 and the feature vectors can be used by a scoring block 206 of the recognizer 214 to compute a similarity score for each state of each word. The recognizer 214 also can include decision logic 208 to determine a best similarity score for each word. The recognizer 214 can generate a score for each word on a frame by frame basis. In a disclosed embodiment of the recognizer 214, a best similarity score is the highest or maximum similarity score. As illustrated, the decision logic 208 determines the recognized or matched word corresponding to the best similarity score. The recognizer 214 is generally used to generate a word representing a transcription of an observed utterance. In a disclosed embodiment, the ASR engine 124 is implemented with fixed-point software or firmware. The trainer 212 provides word models, such as Hidden Markov Models (HMM) for example, to the recognizer 214. The recognizer 214 serves as both the speaker dependent recognizer and the speaker independent recognizer. Other ways of modeling or implementing a speech recognizer such as with the use of neural network technology will be apparent to those skilled in the art. A variety of speech recognition technologies are understood to those skilled in the art.

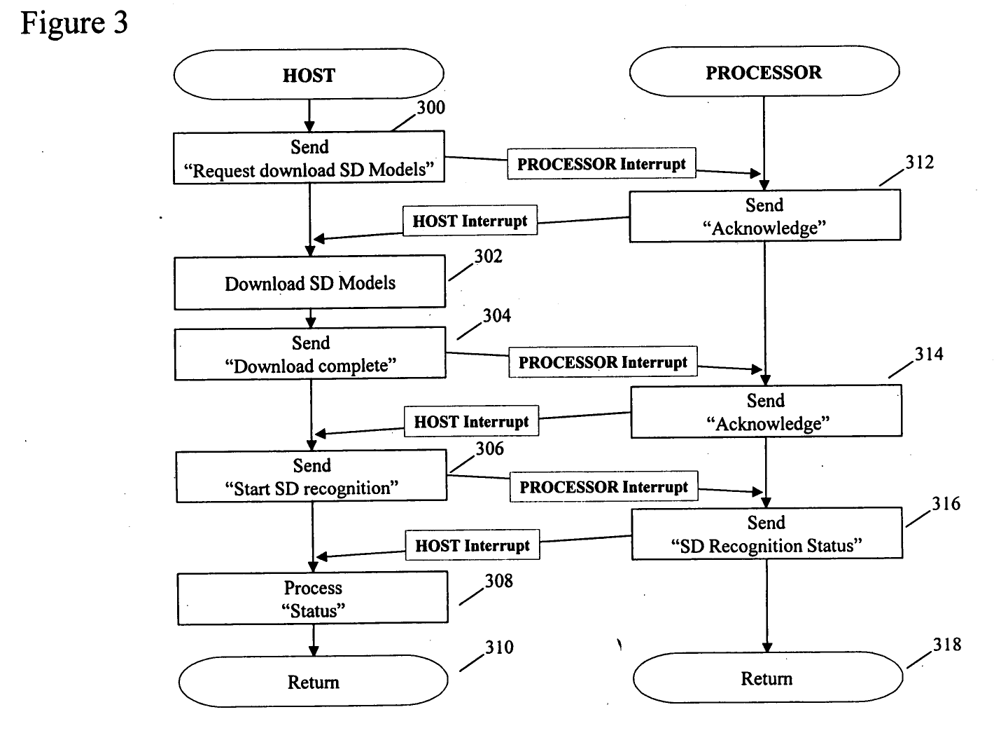

Referring to FIG. 3, control flow between the host controller 102 and the processor 108 for speaker dependent mode command processing is shown. Beginning in step 300, the host controller 102 sends a request to download the SD models 112 from the memory 110 to the working memory 116. Next, in step 312, the processor 108 sends an “acknowledge” response to the host controller 102 to indicate acknowledgement of the download of the SD models 112. It is noted that the commands generated by the host controller 102 may be in the form of processor interrupts, and replies or responses generated by the processor 108 may be in the form of host interrupts. In step 312, control flow returns to the host controller 102 in step 302. In step 302, the host controller 102 loads the speaker dependent models 112 from the memory 110 to the working memory 116. Next, in step 304, the host controller 102 generates a “download complete” signal to the processor 108. Control next proceeds to step 314 where the processor 108 sends an “acknowledge” reply to the host controller 102. From step 314, control proceeds to step 306 where the host controller 102 generates a signal to initiate or start speaker dependent recognition. Control next proceeds to step 316 where the processor 108 generates a speaker dependent recognition status. Between steps 306 and 316, the ASR engine 124 performs automatic speech recognition. From step 316, control proceeds to step 308 where the host controller 102 processes the speaker dependent recognition status received from the processor 108. From step 308, the host controller 102 returns through step 310 to step 300. Similarly, the processor 108 returns through step 318 to step 312. Steps 300-308 and steps 312-316 represent one cycle corresponding to speaker dependent recognition for one word. More particularly, steps 300-308 represent control flow for the host controller 102, and steps 312-316 represent control flow for the processor 108.

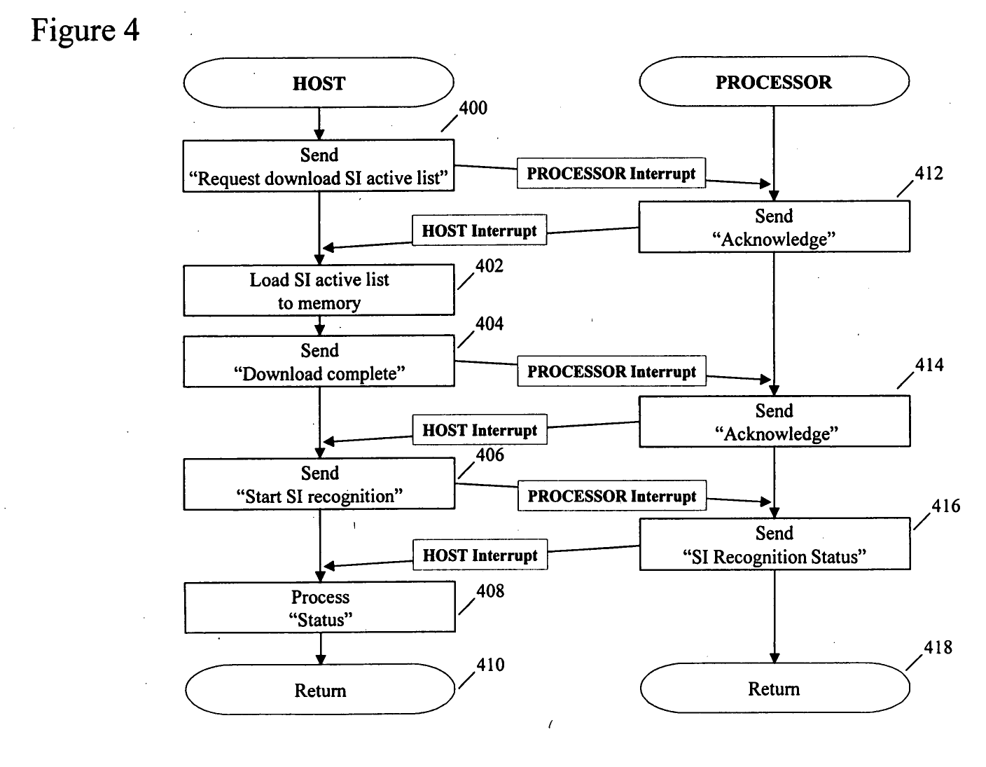

Referring to FIG. 4, control flow between the host controller 102 and the processor 108 is shown for speaker independent command processing. Beginning in step 400, the host controller 102 generates a request to download a speaker independent (SI) active list. The speaker independent active list represents the active set of commands out of the full speaker independent vocabulary. Since only certain words or phrases might be active during the SI mode of the ASR engine 124, the host controller 102 requests to download a speaker independent active list of commands (i.e., active vocabulary) specific to a current menu. Use of menus is described in detail below. From step 400, control proceeds to step 412 where the processor 108 generates an “acknowledge” signal provided to the host controller 102 to acknowledge the requested download. Control next proceeds to step 402 where the host controller 102 loads the speaker independent active list from the memory 120 to the working memory 116. Next, in step 404, the host controller 102 sends a download complete signal to the processor 108. In response, the processor 108 generates an “acknowledge” signal in step 414 to the host controller 102. The host controller 102 in step 406 then generates a command to initiate speaker independent recognition. After speaker independent recognition is performed, the processor 108 generates a speaker independent recognition status in step 416 for the host controller 102. In step 408, the host controller 102 processes the speaker independent recognition status received from the processor 108. As illustrated, the host controller 102 returns from step 410 to step 400, and the processor 108 returns from step 418 to step 412. Like the control flow shown in FIG. 3, the control flow here can take the form of processor interrupts and host controller interrupts. Steps 400-408 and steps 412-416 represent one cycle corresponding to speaker independent recognition for one word.

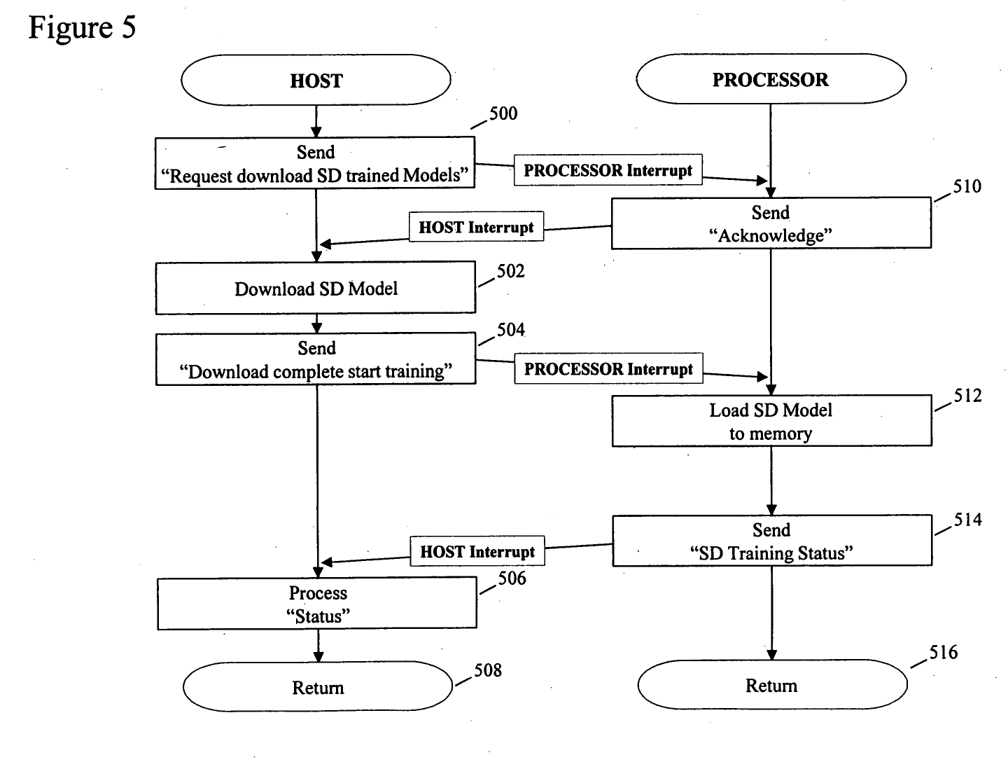

Referring to FIG. 5, control flow between the host controller 102 and the processor 108 for speaker dependent training is shown. Beginning in step 500, the host controller 102 generates a request to download a speaker dependent model 112. In step 510, the processor 108 generates an acknowledge signal to the host controller 102 to acknowledge that request. Next, in step 502, the host controller 102 downloads the particular speaker dependent model 112 from the memory 110. Control next proceeds to step 504 where the host controller 102 generates a command to initiate training. The processor 108 in step 512 then downloads the speaker dependent model 112 from the memory 110 to the working memory 116. From step 512, control proceeds to step 514 where the processor 108 generates a speaker dependent training status for the host controller 102. In step 506, the host controller 102 processes the speaker dependent training status from the processor 108. As shown, the host controller 102 returns through step 508, and the processor 108 returns through step 516. In a training mode of the ASR engine 124, the speaker dependent models are already downloaded. If a word is already trained, then the model includes non-zero model parameters. If a word has not yet been trained, then the model includes initialized parameters such as parameters set to zero.

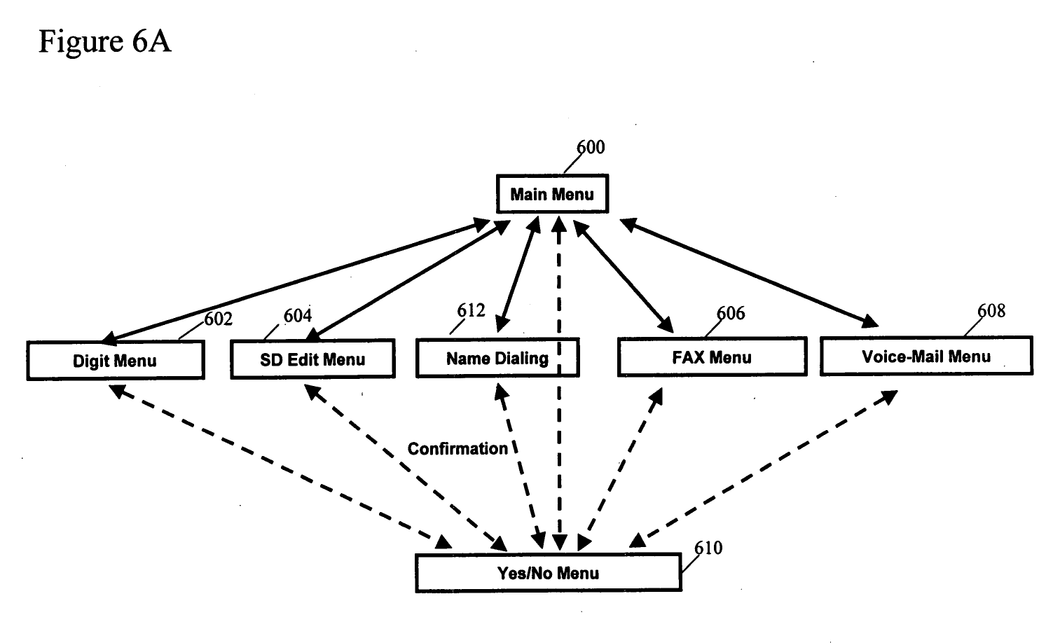

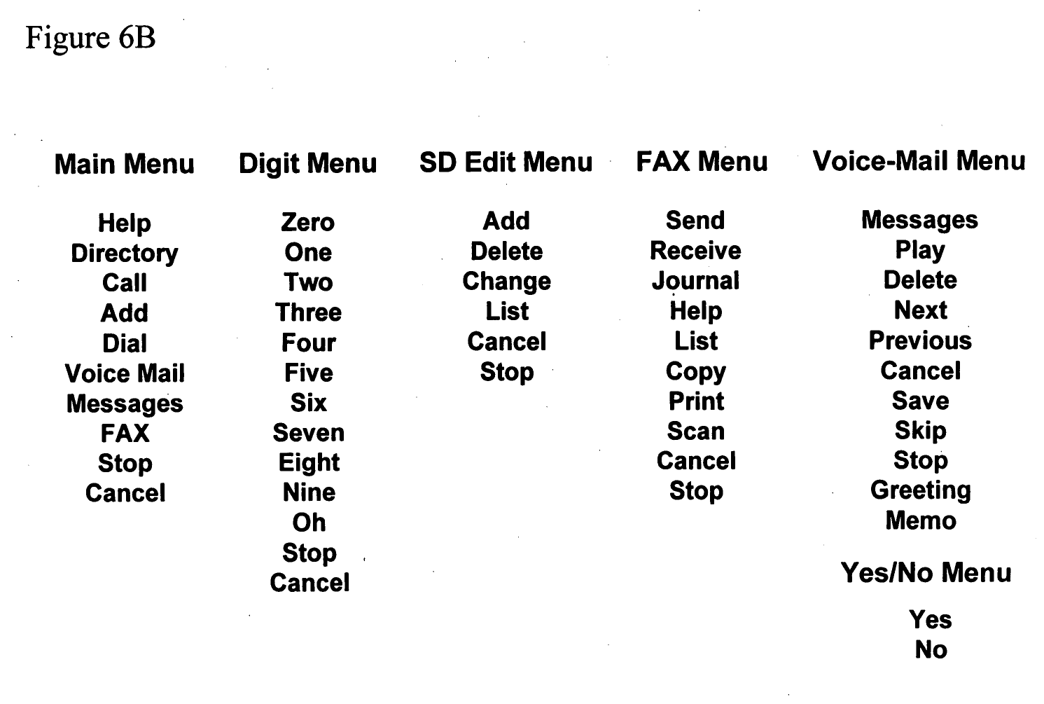

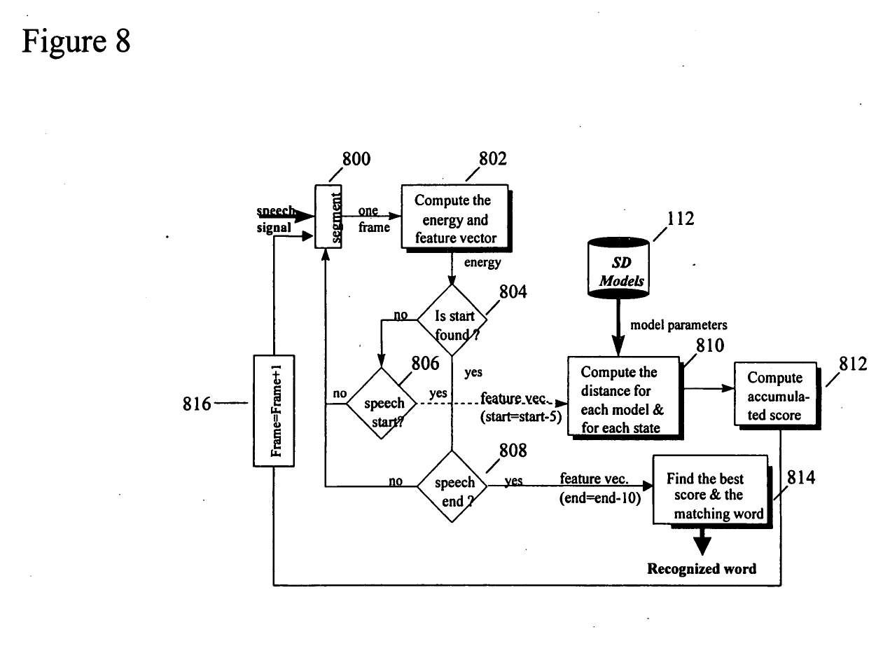

In the SD mode or the SI mode, the ASR system can allow a user to navigate through menus using voice commands. FIG. 6A shows an exemplary menu architecture for the ASR system. The illustrated menus include a main menu 600, a digit menu 602, a speaker dependent edit menu 604, a name dialing menu 612, a telephone answering or voice-mail menu 608, a Yes/No menu 610, and a facsimile menu 606. One menu can be active at a time. From the main menu 600, the ASR system can transition to any other menu. The ASR system provides the flexibility for an application designer to pick and choose voice commands for each defined menu based on the particular application. FIG. 6B shows an exemplary list of voice commands which an application designer might select for the menus shown in FIG. 6A with the exception of the name dialing menu which is user specific. The “call” command mentioned in connection with an example provided in describing FIG. 1 is here shown in FIG. 8 as part of the main menu 600. The nature of the commands shown in FIG. 6B will be appreciated by those skilled in the art. Some of the commands shown in FIG. 6B are described below. If a user says the “directory” command at the main menu 600, then the communications device 100 reads the names trained by the user for the purpose of name dialing. If a user says the “help” command at the main menu level 600, then the communications device 100 can respond “you can say ‘directory’ for a list of names in your directory, you can say ‘call’ to dial someone by name, you can say ‘add’ to add a name to your name-dialing list . . . ” The voice response of the communications device 100 are audible to the user through the speaker 107. If a user says “journal” at the fax menu level 600, then a log of all fax transmissions is provided by the communications device 102 to the user. If a user says “list” at an SD edit menu level 604, then the communications device 100 provides a list of names (trained by the user for name dialing) and the corresponding telephone numbers. If a user says “change” at an SD edit menu level 604, then a user can change a name of a telephone number on the list. If a user says “greeting” at the voice-mail menu level 608, then the user can record/change the outgoing message. If a user says “memo” at the voice-mail menu level 608, then the user can record a personal reminder. These voice commands can be commands trained by a user during the SD training mode or may be speaker independent commands used during the SI mode. It should be understood that the menus and commands are illustrative and not exhaustive. Below is an exemplary list of words and phrases (grouped as general functions, telephone functions, telephone answering device functions, and facsimile functions) which alternatively can be associated with the illustrated menus:

General Functions

| | |
|---|---|
| 0 | zero |
| 1 | one |
| 2 | two |
| 3 | three |
| 4 | four |
| 5 | five |
| 6 | six |
| 7 | seven |
| 8 | eight |
| 9 | nine |
| 10 | oh |
| 11 | pause |
| 12 | star |
| 13 | pound |
| 14 | yes |
| 15 | no |
| 16 | wake-up |
| 17 | stop |
| 18 | cancel |
| 19 | add |
| 20 | delete |
| 21 | save |
| 22 | list |
| 23 | program |
| 24 | help |
| 25 | options |
| 26 | prompt |
| 27 | verify |
| 28 | repeat |
| 29 | directory |
| 30 | all |
| 31 | password |
| 32 | start |
| 33 | change |
| 34 | set-up |

Telephone Functions

| | |
|---|---|
| 35 | Dial |
| 36 | Call |
| 37 | speed dial |
| 38 | re-dial |
| 39 | Page |
| 40 | louder |
| 41 | softer |
| 42 | answer |
| 43 | hang-up |

TAD Functions

| | |
|---|---|
| 44 | voice mail |
| 45 | mail |
| 46 | messages |
| 47 | play |
| 48 | record |
| 49 | memo |
| 50 | greeting |
| 51 | next |
| 52 | previous |
| 53 | forward |
| 54 | rewind |
| 55 | faster |
| 56 | slower |
| 57 | continue |
| 58 | skip |
| 59 | mailbox |

Fax Functions

| | |
|---|---|
| 60 | fax |
| 61 | send |
| 62 | receive |
| 63 | journal |
| 64 | print |
| 65 | scan |
| 66 | copy |
| 67 | broadcast |
| 68 | out-of-vocabulary |

It should be understood that even if these commands are supported in one language in the SI vocabulary that the words may also be trained into the SD vocabulary. While the illustrated commands are words, it should be understood that the ASR engine 124 can be word-driven or phrase-driven. Further, it should be understood that the speech recognition vocabulary performed by the recognizer 214 can be isolated or continuous. With commands such as those shown, the ASR system supports hands-free voice control of telephone or dialing, telephone answering machine and facsimile functions.

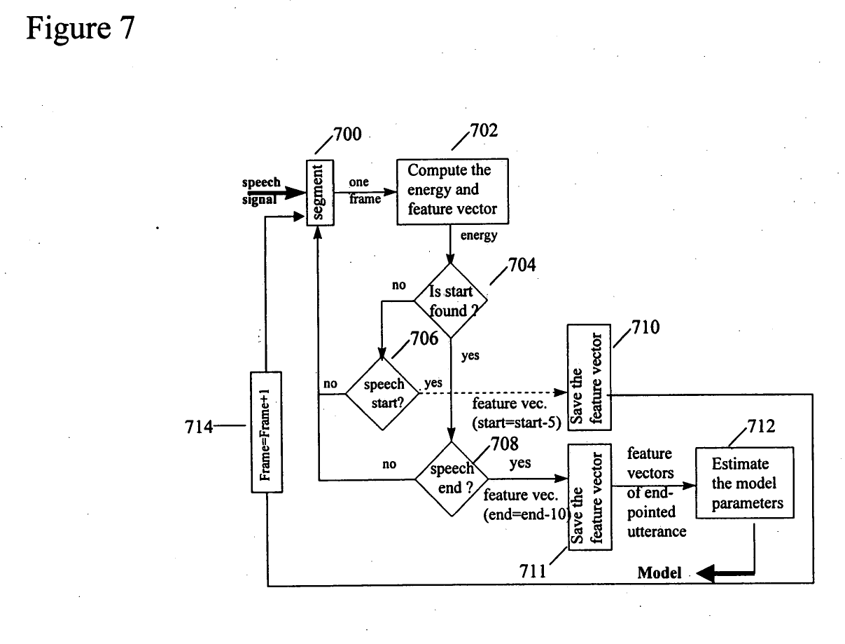

Referring to FIG. 7, an exemplary real time speaker dependent (SD) training process is shown. As represented by step 700, a speech signal or utterance can be divided into a number of segments. For each frame of a segment, the energy and feature vector for that frame can be computed in step 702. It should be understood that alternatively other types of acoustic features might be computed. From step 702, control proceeds to step 704 where it is determined if a start of speech is found. If a start-of speech is found, then control proceeds to step 708 where it is determined if an end of speech is found. If in step 704 it is determined that a start of speech is not found, then control proceeds to step 706 where it is determined if speech has started. Steps 704, 706 and 708 generally represent end-pointing by the ASR engine 124. It should be understood that end-pointing can be accomplished in a variety of ways. As represented by the parentheticals in FIG. 7, for a particular frame of speech, the beginning of speech can be declared to be five frames behind and the end of speech can be declared to be twenty frames ahead. If speech has not started, then control proceeds from step 706 back to step 700. If speech has started, then control proceeds from step 706 to step 710. In step 710, the feature vector is saved. A mean vector and covariance for an acoustic feature might also be computed. From step 710, control proceeds to step 714 where the process advances to the next frame such as by incrementing a frame index or pointer. From step 714, control returns to step 700. In step 708, if speech has ended, then control also proceeds to step 711. In step 711, the feature vector of the end-pointed utterance is saved. From step 711, control proceeds to step 712 where model parameters such as a mean and transition probability (tp) for each state are determined. The estimated model parameters together constitute or form the speech model. For a disclosed embodiment, speaker independent training is handled off-device (e.g., off the communications device 100). The result of the off-device speaker independent training can be downloaded to the memory 110 of the communications device 100.

Referring to FIG. 8, an exemplary recognition process by the ASR engine 124 is shown. In step 800, a particular frame from a segment of a speech signal or utterance is examined. Next, in step 802, the energy and feature vector for the particular frame are computed. Alternatively, other acoustic parameters might be computed. From step 802, control proceeds to step 804 where it is determined if a start of speech is found. If a start of speech is found, then control proceeds to step 808 where it is determined if an end of speech is found. If a start of speech is not found in step 804, then control proceeds to step 806 where it is determined whether speech has started. If speech has not started in step 806, then control returns to step 800. If speech has started in step 806, then control proceeds to step 810. In step 808, if an end of speech is not found, then control returns to step 800. In step 808, if an end of speech is found, then control proceeds to step 814. As represented by the paratheticals, for a particular frame of speech, the beginning of speech can be declared to be five frames behind and the end of speech can be declared to be ten frames ahead.

In step 810, a distance for each state of each model can be computed. Step 810 can utilize word model parameters from the SD models 112. Next, in step 812 an accumulated similarity score is computed. The accumulated similarity score can be a summation of the distances computed in step 810. From step 812, control proceeds to step 816 where the process advances to a next frame such as by incrementing a frame index by one. From step 816, control returns to step 800. It is noted that if an end of speech is determined in step 808, than control proceeds directly to step 814 where a best similarity score and matching word is found.

In a disclosed embodiment, a similarity score is computed using a logarithm of a probability of the particular state transitioning to a next state or the same state and the logarithm of the relevant distance. This computation is known as the Vitterbi algorithm. In addition, calculating similarity scores can involve comparing the feature vectors and corresponding mean vectors. Not only does the scoring process associate a particular similarity score with each state, but the process also determines a highest similarity score for each word. More particularly, the score of a best scoring state in a word can be propagated to a next state of the same model. It should be understood that the scoring or decision making by the recognizer 214 can be accomplished in a variety of ways.

Both the SD mode and the SI mode of the recognizer 214 provide out-of-vocabulary rejection capability. More particular, during a SD mode, if a spoken word is outside the SD vocabulary defined by the SD models 112, then the communications device 100 responds in an appropriate fashion. For example, the communications device 100 may respond with a phrase such as “that command is not understood” which is audible to the user through the speaker 107. Similarly, during a SI mode, if a spoken word is outside the SI vocabulary defined by the SI models 120, then the communications device 100 responds in an appropriate fashion. With respect to the recognizer 214, the lack of a suitable similarity score indicates that the particular word is outside the relevant vocabulary. A suitable score, for example, may be a score greater than a particular threshold score.

Thus, the disclosed communications device provides automatic speech recognition capability by integrating an ASR engine, SD models, SI models, a microphone, and a modem. The communications device may also include a telephone and a speaker. The ASR engine supports an SI recognition mode, an SD recognition mode, and an SD training mode. The SI recognition mode and the SD recognition mode provide an out-of-vocabulary rejection capability. Through the training mode, the ASR engine is highly user configurable. The communications device also integrates an application for utilizing the ASR engine to activate desired communication functions through voice commands from the user via the microphone or telephone. Any of a variety of applications and any of a variety of communication functions can be supported. It should be understood that the disclosed ASR system for an integrated communications device is merely illustrative.

1-25. (canceled)

26. An integrated communications device comprising:
a microphone;
a modem with an automatic speech recognition engine, comprising:
a speaker dependent recognizer;
a speaker independent recognizer; and
an online speaker dependent trainer;
a plurality of context-related speaker independent models accessible to the automatic speech recognition engine; and
a plurality of speaker dependent models accessible to the automatic speech recognition engine, wherein the processor, the plurality of speaker dependent models, and the plurality of context-related speaker independent models are integral to the modem.

27. The communications device of claim 26, further comprising a host controller comprising an automatic speech recognition control module to communicate with the automatic speech recognition engine.

28. The communications device of claim 27, the host controller further comprising an application including the automatic speech recognition control module.

29. The communications device of claim 26, further comprising a storage device coupled to the modem to store the plurality of speaker dependent models accessible to the automatic speech recognition engine.

30. The communications device of claim 26, wherein the plurality of speaker independent models comprise a speaker independent active list corresponding to an active menu of a plurality of menus.

31. The communications device of claim 26, wherein the processor is a digital signal processor.

32. The communications device of claim 26, wherein the automatic speech recognition engine further comprises an offline speaker dependent trainer.

33. The communications device of claim 26, wherein the automatic speech recognition engine rejects words outside a speaker independent vocabulary defined by the plurality of speaker independent models and words outside a speaker dependent vocabulary defined by the plurality of speaker dependent models.

34. A modem configured to support automatic speech recognition capability, the modem comprising:
a processor comprising an automatic speech recognition engine, comprising:
a speaker dependent recognizer;
a speaker independent recognizer;
and an online speaker dependent trainer;
a plurality of context-related speaker independent models accessible to the automatic speech recognition engine; and
a plurality of speaker dependent models accessible to the automatic speech recognition engine, wherein the processor, the plurality of speaker dependent models, and the plurality of context-related speaker independent models are integral to the modem.

35. The modem of claim 34, further comprising a working memory to temporarily store a speaker independent active list of the plurality of speaker independent models accessible to the automatic speech recognition engine, the speaker independent active list corresponding to an active menu of a plurality of menus.

36. The modem of claim 34, further comprising a working memory to temporarily store the plurality of speaker dependent models accessible to the automatic speech recognition engine.

37. The modem of claim 34, wherein the processor and the plurality of speaker independent models are provided on a single modem chip.

38. The modem of claim 34, wherein the automatic speech recognition engine rejects words outside a speaker independent vocabulary defined by the plurality of speaker independent models and words outside a speaker dependent vocabulary defined by the plurality of speaker dependent models.

39. A method of automatic speech recognition using a host controller and a processor of an integrated modem, comprising the steps of:
generating a command by the host controller to load a plurality of context related acoustic models;
generating a command by the host controller for the processor to perform automatic speech recognition by an automatic speech recognition engine;
generating a command by the host controller to initiate online speaker dependent training by the automatic speech recognition engine; and
performing communication functions by the integrated communications device responsive to processing a speech recognition result from the automatic speech recognition engine by the host controller, wherein the plurality of context-related acoustic models comprise a speaker independent model and a speaker dependent model.

40. The method of claim 39, wherein the plurality of acoustic models comprise a speaker independent active list of a plurality of speaker independent models.

41. The method of claim 39, wherein the plurality of acoustic models comprise trained speaker dependent models.

42. The method of claim 39, wherein the automatic speech recognition engine further comprises an offline speaker dependent trainer.

43. The method of claim 39, further comprising the step of rejecting a word outside a speaker independent vocabulary defined by a plurality of speaker independent models, the rejecting step being performed by the automatic speech recognition engine.

44. The method of claim 39, further comprising the step of rejecting a word outside a speaker dependent vocabulary defined by a plurality of speaker dependent models, the rejecting step being performed by the automatic speech recognition engine.

45. The method of claim 39, further comprising the step of recognizing a word in a speaker independent vocabulary defined by a plurality of speaker independent models, the recognizing step being performed by the automatic speech recognition engine.
